(19) United States
(12) Patent Application Publication
(10) Pub. No.: US 2010/0042471 A1
(43) Pub. Date: Feb. 18, 2010

(54) DETERMINATION OF ADVERTISEMENT REFERRER INCENTIVES AND DISINCENTIVES

(75) Inventors: Eric I. Chang, Beijing (CN); Raman Chandrasekar, Seattle, WA (US); Tian Bai, Beijing (CN); Michael Tsang, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/193,683

(22) Filed: Aug. 18, 2008

(51) Int. Cl. G06Q 30/00; G06Q 99/00

(52) U.S. Cl. 705/10; 705/1; 705/14.19

(57) ABSTRACT

A software and/or hardware facility for managing the referral of electronic advertisements is described. The facility may be configured to provide advertisements, including coupons, to a referrer and to enable the referrer to forward the advertisements to recipients. The facility also tracks recipient responses to the forwarded advertisements (e.g., redemption of coupons, interactions with the advertisement, rejections of advertisements, etc.). The facility may also be configured to provide incentives and/or disincentives to referrers based on recipient responses to advertisements.

### BACKGROUND

Users are increasingly using electronic messaging services such as Short Message Service (SMS) messaging, Multimedia Message Service (MMS) messaging, email, and instant messaging (IM) to communicate with their family members, friends, colleagues, and acquaintances. Similarly, social networking services such as Windows Live Spaces, Facebook, and MySpace allow users to communicate with others and enable the creation of social networks.

These and other services have decreased the cost of providing advertisements to large audiences. In some instances, low advertising costs have led to indiscriminate and/or bulk advertising. As another example, pyramid schemes, multi-level marketing, and other viral marketing techniques may provide incentives for users to indiscriminately forward advertisements to others. However, many recipients of these advertisements are annoyed by these advertisements. For example, these users may delete the advertisements, ignore the advertisements, and/or complain to the advertiser or advertisement service provider.

In contrast, advertisements targeted to receptive audiences may result in an increased acceptance of the advertisement, higher user interest, a higher click-through rate, and increased sales. The ability to target advertisements may also result in increased revenue for both advertisers and advertisement service providers.

### SUMMARY

A software and/or hardware facility for managing the referral of electronic advertisements is described. The facility may be configured to provide advertisements, including coupons, to a referrer and to enable the referrer to forward the advertisements to recipients. The facility also tracks recipient responses to the forwarded advertisements (e.g., redemption of coupons, interactions with the advertisement, rejections of advertisements, etc.). The facility may also be configured to provide incentives and/or disincentives to referrers based on recipient responses to advertisements.

This Summary is provided to introduce a selection of concepts in a simplified form that are further described in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a suitable environment for practicing aspects of the invention.

FIG. 2 illustrates a system for managing the referral of electronic advertisements.

FIG. 3 is a logical flow diagram of a process for providing advertisement referrer incentives and disincentives.

FIG. 4 is a logical flow diagram of a process for adjusting advertisement referrer incentives and disincentives.

### DETAILED DESCRIPTION

The following description provides specific details for a thorough understanding of, and enabling description for, various embodiments of the technology. One skilled in the art will understand that the technology may be practiced without many of these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. The term “based on” is not exclusive and is equivalent to the term “based, at least in part, on” and includes being based on additional factors, whether or not the additional factors are described herein. Although certain terms may be emphasized below, any terminology intended to be interpreted in any restricted manner will be overtly and specifically defined as such in this Detailed Description section.

A software and/or hardware facility for managing the referral of electronic advertisements is described. The facility may be configured to provide advertisements, including coupons, to a referrer and to enable the referrer to forward the advertisements to recipients. The facility also tracks recipient responses to the forwarded advertisements (e.g., redemption of coupons, interactions with the advertisement, rejections of advertisements, etc.). The facility may also be configured to provide incentives and/or disincentives to referrers based on recipient responses to advertisements.

This facility may be employed to increase the effectiveness of advertisements by motivating referrers to forward advertisements to likely interested parties. The facility may also discourage the indiscriminate forwarding of advertisements by providing disincentives based on negative recipient responses to forwarded advertisements. In one example, incentives and disincentives may be employed by an advertiser or advertisement service provider (ASP) both to access a referrer's social network and to access the referrer's knowledge of his/her contact's characteristics (e.g., interests, spending habits, lifestyle, plans, personality, etc.) to more appropriately target advertisements. In many cases, referrers may know of characteristics or other information that automated systems may be unable to access or discern. Likewise, recipients may be more likely to respond positively to advertisements sent or forwarded to them by an acquaintance. For example, a recipient may be more likely to open an advertisement, read the advertisement, interact with the advertisement, make a purchase based on the advertisement, and/or the like, if the advertisement is sent or forwarded by an acquaintance. Accordingly, the use of a referrer's knowledge of his/her acquaintance's characteristics may increase an advertisement's effectiveness.

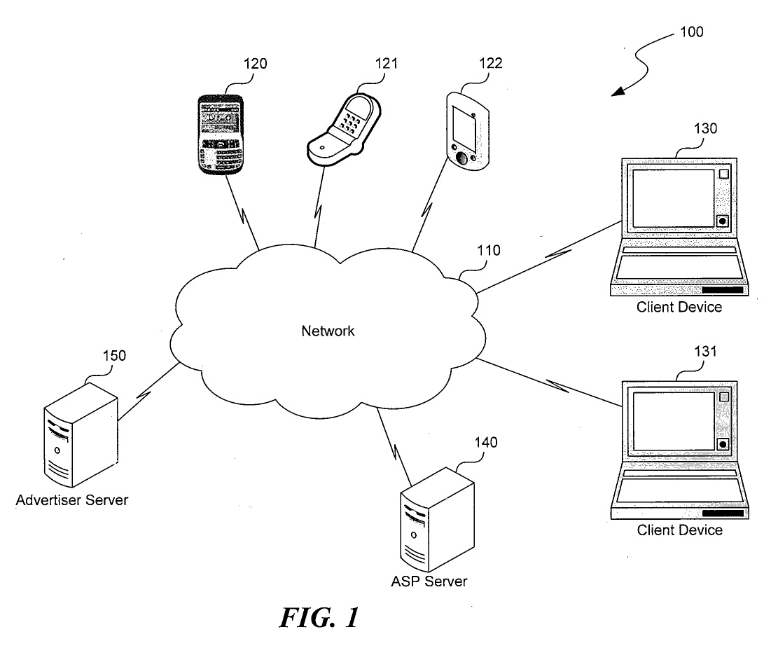

FIG. 1 illustrates a suitable environment in which aspects of the invention may be practiced. However, various modifications, such as the inclusion of additional devices, consolidation and/or deletion of various devices, and the shifting of functionality from one device to another, may be made without deviating from the invention. Environment 100 includes network 110, mobile devices 120-122, client devices 130-131, ASP server 140, and advertiser server 150.

Network 110 is configured to interconnect various computing devices such as mobile devices 120-122, client devices 130-131, ASP server 140, and advertiser server 150 to each other and to other resources. In addition, network 110 may include any number of wired and/or wireless networks including the Internet, intranets, local area networks (LANs), metropolitan area networks (MANs), wide area networks (WANs), personal area networks (PANs), direct connections, and/or the like. Additional computing devices such as routers, network switches, hubs, modems, firewalls, gateways, Radio Network Controllers (RNCs), proxy servers, access points, base stations, and/or the like may be employed to facilitate communications.

Further, the various computing devices may be interconnected with T1 connections, T3 connections, OC3 connections, frame relay connections, Asynchronous Transfer Mode (ATM) connections, microwave connections, Ethernet connections, token-ring connections, Digital Subscriber Line (DSL) connections, and/or the like. In addition, network 110 may also utilize any wireless standard and/or protocol. These include, for example, Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Universal Mobile Telecommunications System (UMTS), Advanced Mobile Phone System (AMPS), Worldwide Interoperability for Microwave Access (WiMAX), Wireless Fidelity (WiFi), and/or the like.

Mobile devices 120-122 may include virtually any portable computing devices capable of receiving and sending messages over a network, such as network 110. Such devices include portable devices such as cellular telephones, display pagers, radio frequency (RF) devices, infrared (IR) devices, Personal Digital Assistants (PDAs), handheld computers, laptop computers, wearable computers, tablet computers, integrated devices combining one or more of the preceding devices, and/or the like. As such, mobile devices 120-122 range widely in terms of capabilities and features. For example, a cellular telephone may have a numeric keypad and the capability to display only a few lines of text. However, other cellular telephones (e.g., smart phones) may have a touch-sensitive screen, a stylus, and a relatively high-resolution display.

Mobile devices 120-122 may typically include a processing unit, volatile memory and/or nonvolatile memory, a power supply, one or more network interfaces, an audio interface, a display, a keypad or keyboard, a Global Positioning System (GPS) receiver and/or other location determination device, and other input and/or output interfaces. Also, the various components of mobile devices 120-122 may be interconnected via a bus.

The volatile and nonvolatile memories generally include computer storage media for storing information such as computer readable instructions, data structures, program modules or other data. Some examples of information that may be stored include basic input/output systems (BIOS), operating systems, and applications. In addition, the memories may be employed to store operational data, content, contexts, and/or the like.

The memories may also store one or more client applications that are configured to receive, forward, and/or provide content, such as advertisements, from and/or to another computing device. Content may also be displayed and/or stored on mobile devices 120-122. The content may include advertisements contained within SMS messages, MMS messages, instant messaging (IM) messages, enhanced message service (EMS) messages, and/or any advertisements or other content directed toward a user (e.g., referrers and/or recipients) of mobile devices 120-122, such as audio data, multimedia data, photographs, video data, still images, text, graphics, animation files, voice messages, and text messages. The memories may also store one or more client applications that are configured to enable a user to respond to an advertisement (e.g., redeem a coupon, interact with an advertisement, reject an advertisement, etc.). As discussed below, these and other applications may be utilized by an advertisement referrer and/or advertisement recipient to forward and/or respond to an advertisement.

Mobile devices 120-122 may also provide identifiers to other computing devices. These identifiers may include identification of a type, capability, and/or name of the particular mobile devices. In one embodiment, mobile devices 120-122 may uniquely identify themselves and/or identify a group association through any of a variety of mechanisms, including a phone number, a Mobile Identification Number (MIN), an electronic serial number (ESN), a Media Access Control (MAC) address, a personal identification number (PIN), an RF signature, and/or other identifier.

Client devices 130-131 may include virtually any computing devices capable of communicating over a network. Typically, client devices 130-131 are computing devices such as personal computers (PCs), multiprocessor systems, microprocessor-based or programmable consumer electronic devices, and/or the like. In addition, client devices 130-131 may be televisions, digital video recorders, media center devices, set-top boxes, other interactive television devices, and/or the like. Also, client devices 130-131 may store and/or execute client applications with the same or similar functionality as those stored on the memories of mobile devices 120-122. For example, client devices 130-131 may store one or more client applications that are configured to enable a user to respond to an advertisement (e.g., redeem a coupon, interact with an advertisement, reject an advertisement, etc.). As discussed below, these and other applications may be utilized by an advertisement referrer and/or advertisement recipient to forward and/or respond to an advertisement.

ASP server 140 may include any computing device capable of connecting to network 110 to provide advertisements to users of mobile devices 120-122 and/or client devices 130-131. ASP server 140 may also be configured to track/monitor the forwarding of advertisement and/or responses to advertisements. Devices that may operate as ASP server 140 include personal computers, desktop computers, multiprocessor systems, microprocessor-based or programmable consumer electronic devices, servers, and/or the like. Likewise, ASP server 140 may include a single computing device, the functionality of ASP server 140 may be distributed across multiple computing devices, or ASP server 140 may be integrated into another device such as an SMS gateway, an advertisement server, advertiser information, and/or the like.

Advertiser server 150 may include virtually any computing device capable of communicating over a network. Typically, advertiser device 150 is a computing device such as a personal computer, multiprocessor system, microprocessor-based or programmable consumer electronic device, and/or the like. Also, advertiser server 150 may be utilized by an advertiser to provide advertisements and/or other information to ASP server 140 and/or mobile devices 120-122 and/or to track/monitor the forwarding of advertisements and/or responses to advertisements. Also, advertiser server 150 may be configured to operate as a merchant platform (e.g., an online merchant web server, a point-of-sale cash register or terminal, network-enabled vending machine, inventory management system, telephone sales system, etc.). In addition, advertiser server 150 may also be employed to provide information corresponding to advertisements, such as targeting information, advertising budget, advertising campaign characteristics, and/or the like.

Additional details regarding mobile devices 120-122, client devices 130-131, ASP server 140, advertiser server 150, and the functionalities thereof are discussed below.

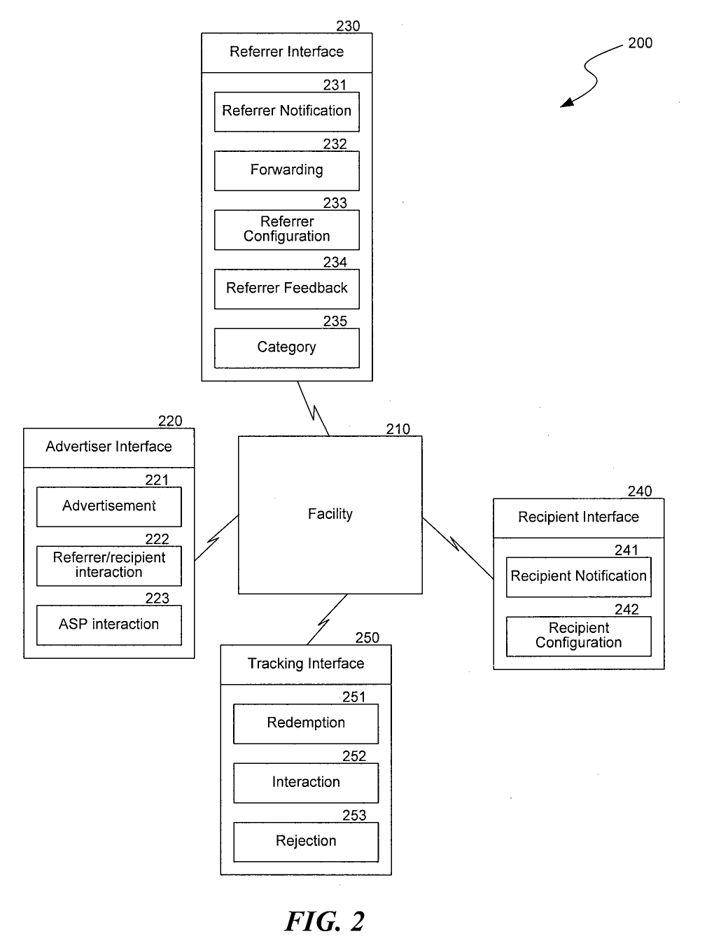

FIG. 2 illustrates electronic advertisement management system 200. As illustrated, system 200 includes facility 210, configured to receive inputs from multiple sources and multiple input sources. The input sources may include advertiser interface 220, referrer interface 230, and recipient interface 240. For clarity, system 200 and the functionalities thereof are described below as being performed by particular elements of environment 100 of FIG. 1. However, system 200 and the functionalities thereof may also be, for example, performed by or on other processors, elements, or devices whether or not such processors, elements, or devices are described herein.

Facility 210 may include a software and/or hardware facility for managing the referral of electronic advertisements. For. example, facility 210 may provide advertisements, such as coupons, to a referrer and enable the referrer to redeem the coupon. The facility may also enable referrers to forward advertisement to recipients and provide incentives and/or disincentives to referrers based on recipient response to forwarded advertisements. In addition, incentives and disincentives may be adjusted based on the effectiveness of referrers at forwarding advertisements to interested recipients.

Facility 210 may be implemented on any device. For example, facility 210 may be implemented on ASP server 140 or advertiser server 150 and configured to receive inputs from mobile devices 120-122 and/or client devices 130-131. However, facility 210 may also be implemented on and/or configured to receive input from any other suitable devices. Likewise, the illustrated input sources are provided merely to illustrate some of the many possible input sources for such a facility. In other systems, other, different, fewer, and/or additional inputs may also be suitably employed.

Facility 210 may receive input from, and communicate with, an advertiser via advertiser interface 220. As illustrated, advertiser interface 220 includes advertisement module 221, referrer/recipient interaction module 222, and ASP interaction module 223. In one example, advertiser interface 220 may be implemented on advertiser server 150. However, it may also be implemented on mobile devices 120-122, client devices 130-131, and/or any other suitable device.

Advertisement module 221 may be configured to provide advertisements and other corresponding information to facility 210. Advertisements may include virtually any information that an advertiser presents to an audience in any format or through any medium. Non-limiting examples of suitable advertisements include coupons, textual advertisements, notifications of upcoming events, notifications of promotions, and/or the like. Also, advertisements may be either commercial or noncommercial in nature. For example, advertisements may be included with and/or intended for electronic delivery via email, SMS messages, MMS messages, and/or the like. However, other delivery methods may also be suitably employed. Advertisement module 221 may also be configured to provide corresponding information to facility 210. Corresponding information may include targeting information, budget information, advertising campaign characteristics, and/or the like.

Referrer/recipient interaction module 222 may be configured to enable interaction between an advertiser and users who receive advertisements. For example, referrer/recipient interaction module 222 may be configured to provide additional information regarding a product and/or service, to conduct transactions with users, to track recipient responses to advertisements, to collect information regarding users, and/or the like. In one example, referrer/recipient interaction module 222 includes an advertiser's point-of-sale device configured to track redemption of coupons provided in advertisements. However, other devices may also suitably function as referrer/recipient interaction module 222.

ASP interaction module 223 may be configured to enable interaction between an advertiser and an ASP. For example, ASP interaction module 223 may enable communication of advertising budget information, advertisement effectiveness information, advertisement response information, and/or the like, between ASP server 140 and advertiser server 150. In one system, ASP interaction module 223 is configured to provide real-time communications between an ASP and an advertiser. However, in other systems, ASP interaction module 223 may provide delayed communications, batched communications, periodic communications, and/or the like.

Referrer interface 230 may also be provided to enable facility 210 to receive input from, and to communicate with, a referrer. As illustrated, referrer interface 230 includes referrer notification module 231, forwarding module 232, referrer configuration module 233, referrer feedback module 234, and category module 235. In one example, referrer interface 230 may be implemented on mobile devices 120-122 or client devices 130-131. However, it may also be implemented on ASP server 140, advertiser server 150, and/or any other suitable device.

Referrer notification module 231 may be configured to notify a referrer of an incoming advertisement. For example, referrer notification module 231 may include an email client application, a SMS client application, a really simple syndication (RSS) client application, and/or the like. Referrer notification module 231 may also be selectively configured to notify a referrer of incoming messages based on the referrer's context as further discussed in the concurrently filed U.S. Patent Application entitled “Context Based Advertisement Filtration” by E. Chang et al. having attorney docket number 418268483US, the entirety of which is hereby incorporated by reference.

Forwarding module 232 may be provided to enable a referrer to forward advertisements to one or more recipients. In one example, a referrer may employ forwarding module 232 to forward a coupon that the referrer does not plan to redeem. However, forwarding module 232 may also be employed to indicate that facility 210 should send a same or similar advertisement to a recipient (e.g., if the referrer intends to redeem a serialized coupon) or to otherwise provide an advertisement to a recipient. As used herein, these and other actions undertaken by, or on behalf of a referrer, are within the meaning of “forward” and agglutinates thereof.

Forwarding module 232 may also be configured to provide an indication to facility 210 that an advertisement has been forwarded to one or more recipients. However, facility 210 may also be configured to track the forwarding of advertisements based on advertisement identifiers (e.g., unique or non-unique serial numbers, barcodes, coupon codes, tracking numbers, telephone numbers, email addresses, user identifiers, etc.) that may be provided, changed, or appended to a forwarded advertisement by forwarding module 232.

Forwarding module 232 may also be configured to suggest potential recipients to a referrer. For example, forwarding module 232 may suggest recipients based on stored and/or acquired information such as demographics information, recipient preferences, recipient configurations, a recipient's previous interaction with facility 210, and/or the like. Possible recipients may also be determined from the potential referrer's social networks, address book, contacts list, and/or the like.

Referrer configuration module 233 may provide configuration information to facility 210. The configuration information may include a referrer's configurable preferences, configuration settings, configuration data, and/or schedule information. For example, this information may be provided to facility 210 in order for advertisements to be targeted to the referrer and/or possible recipients. Some examples of suitable configuration information include the hours during which the referrer is willing to receive advertisements, the referred's dietary preferences, the referrer's typical and/or anticipated travel plan, the referrer's calendar information and/or other schedule information, and/or the like. Also, calendar and schedule information may include information regarding the referrer's business meetings, personal meetings, events, task lists, and/or the like.

Referrer configuration module 233 may also include and/or provide advertisement targeting information to facility 210 as further discussed in the concurrently filed U.S. Patent Application entitled “Context Based Online Advertising” by R. Chandrasekar et al. having attorney docket number 418268481US, the entirety of which is hereby incorporated by reference. Referrer configuration module 233 may also include and/or provide advertisement targeting information to facility 210 as further discussed in concurrently filed U.S. Patent Application entitled “Context Based Advertisement Filtration” as incorporated by reference above.

Referrer feedback module 234 may provide feedback to a referrer regarding previously forwarded advertisements. Such feedback may include information regarding a recipient's response to previous advertisements (e.g., redemption rates, interaction rates, whether an advertisement was printed, etc.), incentive account balances, and/or the like. Also, feedback may be provided in any form. For example, specific feedback for each forwarded advertisement and/or recipient, aggregated feedback for all of a referrer's forwarded advertisements, and/or the like may be provided.

In addition, such feedback may indicate each recipient's utilization or other response to previously forwarded advertisements and may be provided either in association with the recipient's identity, anonymously, semi-anonymously, and/or the like. For example, semi-anonymous feedback may enable a referrer to identify a group of recipients who utilized a particular advertisement and to, in the future, send similar advertisements to that group. Feedback may be reported in tables, charts, graphs, and/or the like.

Category module 235 may be provided to categorize received advertisements by any suitable characteristics, such as the value of the offer (e.g., dollar amount of discount, percentage amount of discount, status as free, lack of discount, etc.), the type of offered merchandise (e.g., food, clothes, electronics, events, etc.), the type of content (e.g., video advertisement, text advertisement, coupon, etc.), timing of offer, user-defined categories, and/or the like. Also, category module 235 may employ categorization information to separately determine an advertisement referrer's incentives and disincentives for each category of advertisements, to determine which category of advertisements should be provided to a given referrer, and/or the like. Information provided by category module 235 may be employed to increase advertisement referrer's effectiveness for referrers that are effective at forwarding certain advertisement categories but are ineffective at forwarding other advertisement categories. Category module 235 may also operate in conjunction with referrer feedback module 234 to provide separate feedback for each category.

Recipient interface 240 may be provided to enable facility 210 to receive input from, and to communicate with, a recipient. As illustrated, recipient interface 240 includes recipient notification module 241 and recipient configuration module 242. In one example, recipient interface 240 may be implemented on mobile devices 120-122 or client devices 130-131. However, recipient interface 240 may also be implemented on ASP server 140, advertiser server 150, and/or any other suitable device.

Recipient notification module 241 and recipient configuration module 242 may provide similar information and/or operate as recipient counterparts for referrer notification module 231 and referrer configuration module 233 of referrer interface 230. However, in certain systems, recipient notification module 241 and recipient configuration module 242 may provide and/or include different, more, and/or less information, features, and/or functionalities.

Tracking interface 250 may be employed to continuously and/or periodically provide tracking information to facility 210 regarding forwarded advertisements. The tracking information may include any information regarding forwarded advertisements and/or a recipient's response to forwarded advertisements. Tracking information may then be analyzed to determine referrer incentives and disincentives. In one system, tracking interface 250 is implemented on ASP server 140 and/or advertiser server 150. In one example, tracking interface 250 may be implemented on an ASP server 140 that is configured to receive recipient response information from a recipient's mobile device and from an advertiser's point-of-sale device. However, tracking interface 250 may also be implemented on mobile devices 120-122, client devices 130-131, and/or any other suitable device.

In one example, tracking interface 250 may include redemption module 251, interaction module 252, and rejection module 253. For example, redemption module 251 may be employed to provide information regarding referrer and/or a recipient coupon redemption. Likewise, interaction module 252 may provide interaction data indicative of referrer and/or recipient interaction with an advertisement. For example, interaction data may include whether the referrer and/or recipient viewed the advertisement, requested further information based on the advertisement, made a purchase based on the advertisement, saved the advertisement for later review, printed the advertisement, and/or the like.

Rejection module 253 may provide information regarding referrer and/or recipient rejection of an advertisement. Rejection module 253 may be employed by a referrer and/or recipient to indicate that an advertisement is unwanted, irrelevant, and/or the like. Rejection module 253 may also be configured to infer referrer and/or recipient response to an advertisement based on either passive or active actions. For example, rejection module 253 may be configured to infer a referrer and/or recipient rejection of an advertisement based on whether the advertisement is deleted without being viewed, is viewed for a short duration, is ignored, and/or the like.

In operation, information from these and other interfaces and modules may be employed to determine advertisement incentives and disincentives based on the effectiveness of a referrer's forwarded advertisements. In one example, facility 210 may provide referrer incentives to reward referrers for forwarding advertisements to positively responding recipients while discouraging referrers from forwarding advertisements to recipients who are likely to have a negative response to forwarded advertisements. Facility 210 may, for example, encourage the forwarding of advertisements in a more appropriate manner and reduce the amount of disruption a recipient receives from unwanted and/or irrelevant advertisements.

Facility 210 may also provide incentives and disincentives in any number of suitable ways. For example, monetary, pseudo-monetary, merchandising, or service-related incentives and disincentive, and/or the like, may be provided. In one example pseudo-monetary incentives and disincentives (e.g., Microsoft Points, Linden dollars, TiVo points, etc.) may be employed. In another example, a merchant may offer referrers discounts on either the advertised merchandise or services or may offer discounts on unrelated merchandise or services.

Differing incentives and disincentives may be provided to referrers based on a recipient's response to forwarded advertisements. In one example, one Microsoft Point may be provided to a referrer if a recipient views a forwarded advertisement, ten Microsoft Points may be provided if another recipient redeems a forwarded coupon, and two Microsoft Points may be deducted if a third recipient indicates that a forwarded advertisement is unwanted and/or irrelevant. However, other quantities and/or suitable incentives and disincentives may also be suitably employed.

In addition, incentives and disincentives may be adjusted based on additional factors, such as the number of recipients who redeem coupons as compared to the number of forwarded coupons, the percentage of recipients who view a forwarded advertisement, keeping recipient complaints below a threshold, and/or the like. In addition, these and other factors may be analyzed to increase the incentives for effective advertisement referrers, decrease the incentives for ineffective advertisement referrers, increase the disincentives for ineffective advertisement referrers, disable forwarding privileges for ineffective advertisement referrers, and/or the like. The adjustment of incentives and disincentives may also be made based on either long-term or short-term feedback and other information. Further, responses and/or factors may analyzed to generate referrer and/or recipient profiles. These profiles may also be employed to adjust incentives and disincentives, to recommend recipients to which additional advertisements may be forwarded, and/or the like.

The above examples are provided to illustrate the operation of facility 210. However, these examples merely illustrate some of the many possible inputs for facility 210 and some of the many ways in which facility 210 may determine advertisement referrer incentives and disincentives.

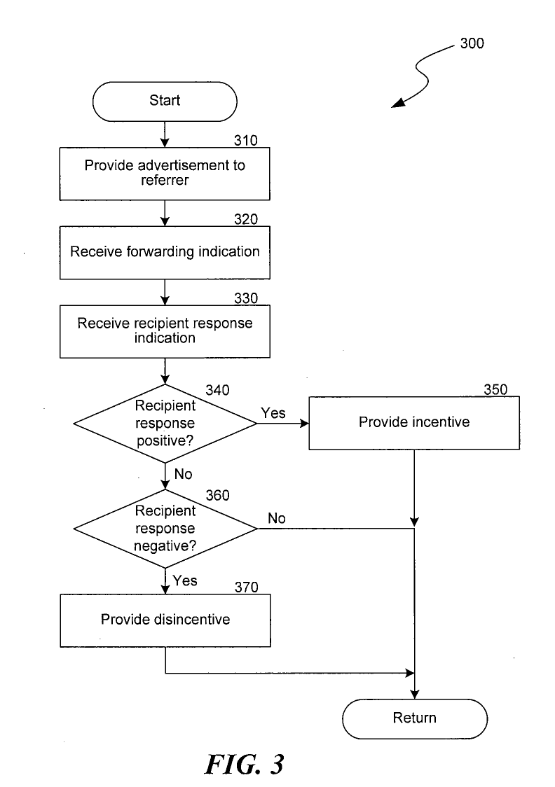

FIG. 3 illustrates process 300 for providing advertisement referrer incentives and disincentives. Process 300 may be implemented in software, hardware, or a combination of hardware and software. As such, the operations illustrated as blocks in FIG. 3 may represent computer-executable instructions that, when executed, provide advertisement referrer incentives and disincentives based on recipient responses to a forwarded advertisement. For clarity, process 300 is described below as being performed by particular elements of system 200 of FIG. 2. However, process 300 may also be performed by other processors, other elements, or in other systems, whether or not such processors, elements, or systems are described herein. Likewise, process 300 may also be a real-time, near real-time, or non-real-time process.

From a start block, processing begins at block 310 where facility 210 provides an advertisement to a referrer. As discussed above, the advertisement may be any type of advertisement, including coupons. The referrer may then forward the provided advertisement to one or more recipients. Processing then flows to block 320 where facility 210 receives notification that the advertisement has been forwarded. In one example, forwarding module 232 may provide this forwarding indication. However, in another example, the forwarding notification may also be combined with a recipient response indication (e.g., combined with block 330).

Processing then flows to block 330 where facility 210 receives a recipient response indication before processing flows to decision block 340. At decision block 340, facility 210 determines whether the recipient response is positive. Facility 210 may determine that a recipient response is positive if, for example, the recipient opened the advertisement, read the advertisement, interacted with the advertisement, made a purchase based on the advertisement, logged in to a service, registered for a service, requested information, and/or the like. If the determined recipient response is positive, facility 210 provides an incentive to the referrer at block 350. From block 350 processing returns to other actions.

If the recipient response is determined to not be positive, processing flows to decision block 360 where facility 210 determines whether the recipient response is negative. Facility 210 may determine that a recipient response is negative if, for example, the advertisement is deleted without being read, the advertisement is viewed for a short duration, the advertisement is ignored, the recipient flags the advertisement as an unwanted advertisement, the recipient manually rejects and/or complains about the advertisement, and/or the like. If the determined recipient response is negative, a disincentive is provided to the referrer at block 370. From block 370, processing returns to other actions. In other examples, from block 350 or 370, processing may instead flow to block 310, 320, or 330 to iteratively provide any number of additional incentives and/or disincentives.

However, if the recipient response is neither positive nor negative, processing may return to other actions without providing either a referrer incentive or disincentive.

Those skilled in the art will appreciate that the blocks shown in FIG. 3 may be altered in a variety of ways. For example, the order of blocks may be rearranged, sub-steps may be performed in parallel, shown blocks may be omitted, or other blocks may be included, etc.

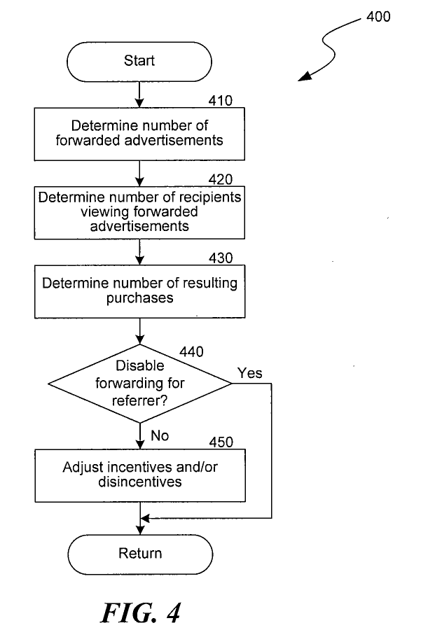

FIG. 4 illustrates process 400 for adjusting advertisement referrer incentives and disincentives. Process 400 may be implemented in software, hardware, or a combination of hardware and software. As such, the operations illustrated as blocks in FIG. 4 may represent computer-executable instructions that, when executed, adjust advertisement referral incentives and disincentives. For clarity, process 400 is described below as being performed by particular elements of system 200 of FIG. 2. However, process 400 may also be performed by other processors, other elements, or in other systems, whether or not such processors, elements, or systems are described herein. Likewise, process 400 may also be a real-time, near real-time, or non-real-time process.

From a start block, processing begins at block 410 where facility 210 determines a number of advertisements that have been forwarded. For example, facility 210 may make this determination based on information provided by forwarding module 232, by counting a number of forwarding indications, and/or the like. From block 410, processing flows to block 420 then to block 430. At block 420 and block 430, respectively, facility 210 determines the number of recipients who viewed the forwarded advertisements and the number of purchases resulting from the forwarded advertisements.

From block 430, processing flows to decision block 440 where facility 210 determines whether to disable forwarding privileges for a referrer. For example, facility 210 may disable forwarding privileges for a particular referrer if a given percentage and/or number of recipients reject, ignore, and/or complain about advertisements forwarded by that referrer. If facility 210 disables forwarding privileges for the particular referrer, processing flows to the return block. Otherwise, processing continues at block 450.

At block 450, the incentives and/or disincentives for the referrer are adjusted. Incentives and/or disincentives may be adjusted based on the effectiveness of the referrer's forwarding of advertisements, as discussed above. Processing then returns to other actions. In other examples, from decision block 440 or block 450, processing may instead flow to block 410, 420, or 430 to iteratively adjust incentives and/or disincentives.

Those skilled in the art will appreciate that the blocks shown in FIG. 4 may be altered in a variety of ways. For example, the order of blocks may be rearranged, sub-steps may be performed in parallel, shown blocks may be omitted, or other blocks may be included, etc.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel or may be performed at different times. Further, any specific numbers noted herein are only examples, and alternative implementations may employ differing values or ranges. Those skilled in the art will also appreciate that the actual implementation of a database may take a variety of forms, and the term “database” is used herein in the generic sense to refer to any data structure that allows data to be stored and accessed.

We claim:

1. A method of managing referral of electronic advertisements, comprising:
providing an advertisement to a referrer;
receiving a forwarding indication indicating that the referrer forwarded the advertisement to a recipient;
receiving a response indication indicating a recipient response to the forwarded advertisement;
providing an incentive to the referrer if the response indication is of a first type; and
providing a disincentive to the referrer if the response indication is of a second type, wherein the response indication of the first type is different than the response indication of the second type.

2. The method of claim 1, wherein the receiving the forwarding indication includes:
forwarding the advertisement to the recipient.

3. The method of claim 1, wherein the first type of response indication includes a positive response indication, and wherein the second type includes a negative response indication, and wherein the method further comprises:
adjusting at least one of the incentive or the disincentive based on a percentage of positive response indications to the forwarded advertisement and other forwarded advertisements.

4. The method of claim 3, further comprising:
categorizing the advertisement into one category of multiple categories, wherein the providing the incentive or the providing the disincentive is based on the categorized category of the advertisement, and wherein adjusting at least one of the incentive or the disincentive includes:
separately adjusting at least one of the incentive or the disincentive based on the categorized category of the advertisement.

5. The method of claim 3, further comprising:
selectively disabling forwarding privileges of the referrer based on a percentage of positive response indications to the forwarded advertisement and other forwarded advertisements.

6. The method of claim 3, wherein the adjusting at least one of the incentive or the disincentive includes:
adjusting the incentive and the disincentive based on a percentage of positive response indications to the forwarded advertisement and other forwarded advertisements.

7. The method of claim 1, wherein the advertisement includes at least one of an email advertisement, an instant messaging message advertisement, a Short Message Service advertisement, or a Multimedia Message Service advertisement.

8. The method of claim 1, wherein the forwarding indication is separate from the response indication.

9. The method of claim 1, wherein the first type of response indication indicates at least one of opening the advertisement, reading the advertisement, interacting with the advertisement, making a purchase based on the advertisement, logging in to a service, registering for a service, or requesting information, and wherein the second type indicates at least one of deleting the advertisement without reading the advertisement, ignoring the advertisement, or flagging the advertisement as unwanted.

10. The method of claim 1, further comprising:
determining a first number of forwarded advertisements;
determining a second number or recipients viewing the forwarded advertisements;
determining a third number of recipients purchasing a product or service based on the forwarded advertisement; and
adjusting at least one of the incentive or the disincentive based on the first number and at least one of the second number or the third number.

11. The method of claim 10, wherein adjusting at least one of the incentive or the disincentive includes adjusting both the incentive and the disincentive based on the first number, the second number, and the third number.

12. The method of claim 1, further comprising:
enabling the referrer to select the recipient from the social network of the referrer.

13. A processor-readable medium containing instructions for a method of managing referral of electronic advertisements, wherein the method comprises:
providing an advertisement to a referrer;
enabling the referrer to select the recipient from the social network of the referrer;
receiving a forwarding indication indicating that the referrer forwarded the advertisement to a recipient;
forwarding the advertisement to the recipient;
receiving a response indication indicating a recipient response to the forwarded advertisement;
providing an incentive to the referrer if the response indication is a positive response indication;
providing a disincentive to the referrer if the response indication is a negative response indication;
categorizing the advertisement into one category of multiple categories;
adjusting the incentive associated with each categorized category based on a percentage of positive response indications to the forwarded advertisement and other forwarded advertisements in the associated categorized category; and
adjusting the disincentive associated with each categorized category based on the percentage of negative response indications to the forwarded advertisement and other forwarded advertisements in the associated categorized category.

14. The processor-readable medium of claim 13, wherein the method further comprises:
selectively disabling forwarding privileges of the referrer based on a percentage of positive response indications to the forwarded advertisement and other forwarded advertisements.

15. A computing system configured to manage referral of electronic advertisements, comprising:
a memory;
a first module configured, when executed in the memory, to provide an advertisement to a referrer;
a second module configured, when executed in the memory, to receive a forwarding indication indicating that the referrer forwarded the advertisement to a recipient;
a third module configured, when executed in the memory, to receive a response indication indicating a recipient response to the forwarded advertisement;
a fourth module configured, when executed in the memory, to provide an incentive to the referrer if the response indication is of a first type; and
a fifth module configured, when executed in the memory, to provide a disincentive to the referrer if the response indication is of a second type, wherein the response indication of the first type is different than the response indication of the second type.

16. The computing system of claim 15, wherein the computing system further comprises:
a sixth module configured, when executed in the memory to enable the referrer to select the recipient from the social network of the referrer.

17. The computing system of claim 15, wherein the first type of response indication includes a positive response indication, and wherein the second type includes a negative response indication.

18. The computing system of claim 17, wherein the computing system further comprises:
a sixth module configured, when executed in the memory, to adjust the incentive and the disincentive based on a percentage of positive response indications to the forwarded advertisement and other forwarded advertisements.

19. The computing system of claim 18, wherein the computing system further comprises:
a seventh module configured, when executed in the memory, to categorize the advertisement into one category of multiple categories, wherein the providing the incentive or the providing the disincentive is based on the categorized category of the advertisement, and wherein the sixth module is further configured, when executed in the memory to:
separately adjust the incentive based on the categorized category of the advertisement; and
separately adjust the disincentive based on the categorized category of the advertisement.

20. The computing system of claim 18, wherein the computing system further comprises:
an eighth module configured, when executed in the memory, to selectively disable forwarding privileges of the referrer based on a percentage of positive response indications to the forwarded advertisement and other forwarded advertisements.
